(19) United States
(12) Patent Application Publication
(10) Pub. No.: US 2018/0014056 A1
(43) Pub. Date: Jan. 11, 2018

(54) METHOD AND TERMINAL FOR UGC FEEDBACK AND FEEDBACK INFORMATION DISPLAY

(71) Applicant: TENCENT TECHNOLOGY (SHENZHEN) COMPANY LIMITED, Shenzhen (CN)

(72) Inventors: Zhenwei ZHANG, Shenzhen (CN); Xinlei ZHANG, Shenzhen (CN)

(21) Appl. No.: 15/711,287

(22) Filed: Sep. 21, 2017

Related U.S. Application Data
(63) Continuation of application No. PCT/CN2016/082558, filed on May 18, 2016.

(30) Foreign Application Priority Data
Oct. 23, 2015 (CN) 201510698161.7

(51) Int. Cl. H04N 21/2743; G11B 27/36; G06Q 50/00

(52) U.S. Cl. CPC H04N 21/2743; G06Q 50/01; G11B 27/36

(57) ABSTRACT

The disclosure includes a method for providing feedback on UGC (user generated content) by a user. The method includes: displaying UGC provided by a social-network friend of the user; detecting a starting time-point of a continuous operation on the displayed UGC; counting time from the starting time-point of the continuous operation to obtain a timing duration in real-time; playing a sequence of quantified feedback images that vary as the timing duration increases, until the playing of the sequence of the quantified feedback images is completed or the continuous operation ends; and generating quantified feedback information matching the quantified feedback image displayed when the playing of the sequence of the quantified feedback images is completed or the continuous operation ends, and notifying a terminal logged in by the social-network friend.

### RELATED APPLICATION

This application is a continuation application of PCT Patent Application No. PCT/CN2016/082558, filed on May 18, 2016, which claims priority to Chinese Patent Application No. 201510698161.7, entitled “METHOD AND TERMINAL FOR UGC FEEDBACK AND FEEDBACK INFORMATION DISPLAY” filed with the Chinese Patent Office on Oct. 23, 2015, which is incorporated herein by reference in its entirety.

### FIELD OF THE TECHNOLOGY

The present invention relates to the technical field of social networks and, in particular, to a method and a terminal for providing feedback on UGC (user generated content) and displaying feedback information.

### BACKGROUND OF THE DISCLOSURE

As computer and network technologies become popular, communications among people are not limited by space and distance. Users of social-network applications at different places can make social-network friends through social networks, and perform interaction based on the social networks.

An important form for the users to interact is transferring UGC (user generated content) to social-network friends. For example, if user A finds a short film, a segment of audio, or an article on the network, the user A can transfer the short film, the audio, or the article to the social-network friends of user A. In this way, the social-network friends of the user A can pull the UGC transferred by the user A when entering a particular page of a social-network application.

A user can provide feedback on the UGC transferred by social-network friends, for example, writing a comment. However, the user needs to type and enter a lot of characters and, thus, the operation can be complex. Therefore, the user may possibly give up commenting when there is a large amount of UGC. As a result, interactions among the users are reduced.

At present, there is a more convenient way for providing feedback on the UGC. When displaying the UGC provided by the social-network friend, the social-network application displays a corresponding quick feedback control, and the user can quickly generate feedback information by clicking the quick feedback control. The way in which the user generates the feedback information by clicking the quick feedback control may be referred to as “like”.

However, at present, although providing feedback on the UGC through the quick feedback control is convenient, little information can be transferred. At present, this method is basically a way to say “have read”, reducing the social network interactivity among users.

### SUMMARY

According to embodiments of this application, a method for providing feedback on UGC, a method for displaying feedback information, and a terminal are provided.

An aspect of the present disclosure includes a method for providing feedback on UGC (user generated content) by a user. The method includes: displaying UGC provided by a social-network friend of the user; detecting a starting time-point of a continuous operation on the displayed UGC; counting time from the starting time-point of the continuous operation to obtain a timing duration in real-time; playing a sequence of quantified feedback images that vary as the timing duration increases, until the playing of the sequence of the quantified feedback images is completed or the continuous operation ends; and generating quantified feedback information matching the quantified feedback image displayed when the playing of the sequence of the quantified feedback images is completed or the continuous operation ends, and notifying a terminal logged in by the social-network friend.

Another aspect of the present disclosure includes a method for displaying feedback information for a user. The method includes: obtaining UGC (user generated content) and transferring the UGC to a terminal logged in by a social-network friend of the user; obtaining quantified feedback information generated by the terminal after displaying the transferred UGC and according to a continuous operation on the displayed UGC on the terminal, where the quantified feedback information matches a timing duration of the continuous operation; displaying the UGC and the corresponding quantified feedback information; and playing a sequence of quantified feedback images that vary as a play time increases, until the playing of the sequence of the quantified feedback images is completed or until the play time reaches the timing duration of the continuous operation.

Another aspect of the present disclosure includes a terminal providing feedback on UGC (user generated content) by a user. The terminal includes a memory storing instructions; and a processor coupled to the memory. When executing the instructions, the processor is configured for: displaying UGC provided by a social-network friend of the user; detecting a starting time-point of a continuous operation on the displayed UGC; counting time from the starting time-point of the continuous operation to obtain a timing duration in real-time; playing a sequence of quantified feedback images that vary as the timing duration increases, until the playing of the sequence of the quantified feedback images is completed or the continuous operation ends; and generating quantified feedback information matching the quantified feedback image displayed when the playing of the sequence of the quantified feedback images is completed or the continuous operation ends, and notifying a terminal logged in by the social-network friend.

Details of one or more embodiments of the present disclosure are provided in the following accompanying drawings and descriptions. Other features, objectives, and advantages of the present disclosure become more obvious with reference to the specification, the accompanying drawings, and the claims.

### BRIEF DESCRIPTION OF THE DRAWINGS

To describe the technical solutions in the embodiments of the present invention, the following briefly describes the accompanying drawings for describing the embodiments. Apparently, the accompanying drawings in the following description show merely some embodiments of the present invention, and a person of ordinary skill in the art may derive other drawings from these accompanying drawings without creative efforts.

FIG. 1 is an application environment diagram of a social network interaction system according to an embodiment;

FIG. 2 is a schematic diagram of a terminal according to an embodiment;

FIG. 3 is a schematic flowchart of a method for providing feedback on UGC according to an embodiment;

FIG. 4 is a schematic diagram of a UGC display page on a terminal displaying UGC provided by a social-network friend according to an embodiment;

FIG. 5 is a schematic diagram of a UGC display page on a terminal displaying a sequence of quantified feedback images changing with increased timing duration according to an embodiment;

FIG. 6 is a schematic diagram of a UGC display page on a terminal displaying another sequence of quantified feedback images changing with increased timing duration according to another embodiment;

FIG. 7 is a schematic diagram of a UGC display page on a terminal displaying another sequence of quantified feedback images changing with increased timing duration according to still another embodiment;

FIG. 8 is a schematic diagram of a UGC display page on a terminal displaying another sequence of quantified feedback images changing with increased timing duration according to an embodiment;

FIG. 9 is a schematic flowchart of detecting a starting time-point of an operation for performing a continuous operation on displayed UGC according to an embodiment;

FIG. 10 is a schematic diagram that a terminal displays a sequence of quantified feedback images that have a fillable area and an area of a filled area in the fillable area is correspondingly increased as timing duration increases according to an embodiment;

FIG. 11 is another schematic diagram that a terminal displays a sequence of quantified feedback images that have a fillable area and an area of a filled area in the fillable area is correspondingly increased as timing duration increases according to an embodiment;

FIG. 12 is a schematic diagram that an image element in a preset area moves as timing duration increases according to an embodiment;

FIG. 13 is a schematic diagram that an image element in a preset area diffuses outward the preset area according to an embodiment;

FIG. 14 is a schematic flowchart of generating a feedback record according to an embodiment;

FIG. 15 is a schematic flowchart of a method for displaying feedback information according to an embodiment;

FIG. 16 is a schematic diagram that a terminal displays a prompt in a system notification bar to indicate that quantized feedback of UGC is triggered and quantified feedback information is generated according to an embodiment;

FIG. 17 is a schematic diagram of displaying UGC and corresponding quantified feedback information according to an embodiment;

FIG. 18 is a schematic diagram that a terminal displays a sequence of quantified feedback images that vary as a play time increases by using a floating layer according to an embodiment;

FIG. 19 is a structural block diagram of a device for providing feedback on UGC according to an embodiment;

FIG. 20 is a structural block diagram of a device for providing feedback on UGC according to another embodiment;

FIG. 21 is a structural block diagram of a device for displaying feedback information according to an embodiment; and

FIG. 22 is a structural block diagram of a device for displaying feedback information according to another embodiment.

### DESCRIPTION OF EMBODIMENTS

To make the objectives, technical solutions, and advantages of the present disclosure clearer, the present disclosure is further described in detail with reference to the accompanying drawings and the embodiments. It should be understood that the specific embodiments described herein are merely intended to explain the present disclosure, but are not intended to limit the present disclosure.

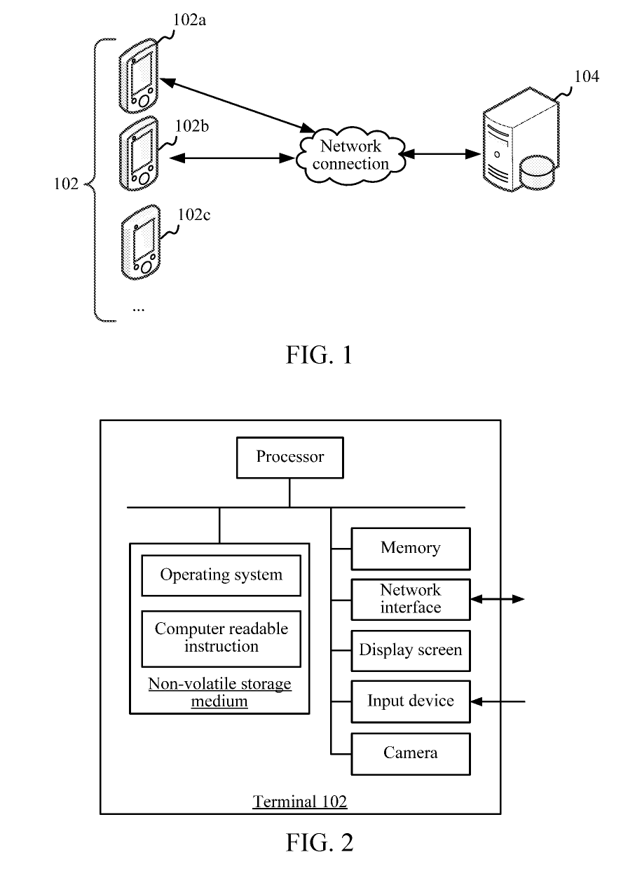

As shown in FIG. 1, in an embodiment, a social network interaction system is provided, including multiple terminals 102 (for example, terminals 102a, 102b, and 102c in FIG. 1) and a server 104. Each terminal 102 is connected to the server 104 through a network, and the server 104 is configured to transfer information to each terminal 102. The terminal 102 may be a desktop computer or a mobile terminal. The mobile terminal includes at least one of a mobile phone, a tablet computer, and a wearable device. The wearable device includes at least one of a smart watch, a sport bracelet, and the like. The server 104 may be a single physical server or a cluster of physical servers.

As shown in FIG. 2, in an embodiment, a terminal 102 is provided, including a processor, a non-volatile storage medium, a memory, a network interface, a display screen, a camera, and an input device that are connected by using a system bus. The processor has a computing function and a function of controlling the terminal 102 to work. The processor is configured to perform a method for providing feedback on UGC and/or a method for displaying feedback information. The non-volatile storage medium includes a magnetic storage medium, an optical storage medium, and a flash storage medium. The non-volatile storage medium stores an operating system, and further stores a computer readable instruction. When executed by the processor, the computer readable instruction may cause the processor to perform a method for providing feedback on UGC and/or a method for displaying feedback information. The memory is configured to provide caches for the operating system and the computer readable instruction. The display screen may be a liquid crystal display screen or an electronic ink display screen. The input device includes a touchpad, a track ball, a mouse, and a touch layer overlapping the display screed, and the display screen and the touch layer form a touchscreen. The network interface is configured to be connected to a network. The camera is configured to obtain, by using a photosensitive device thereof, an external image to form a digital signal and transfer the digital signal to the processor for processing.

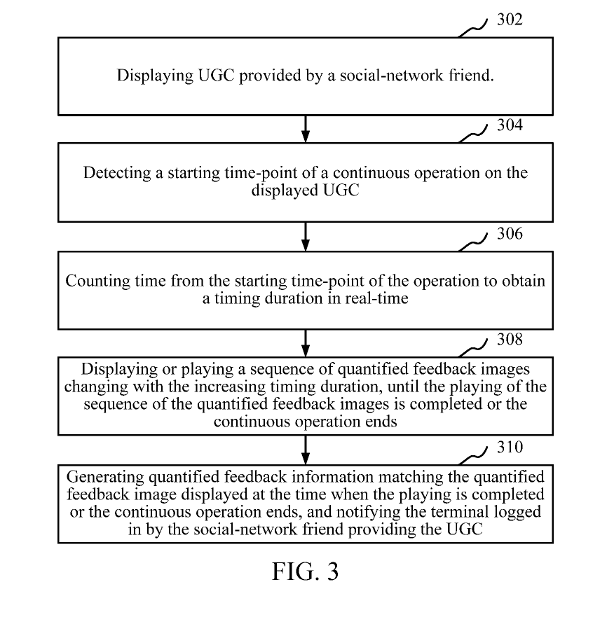

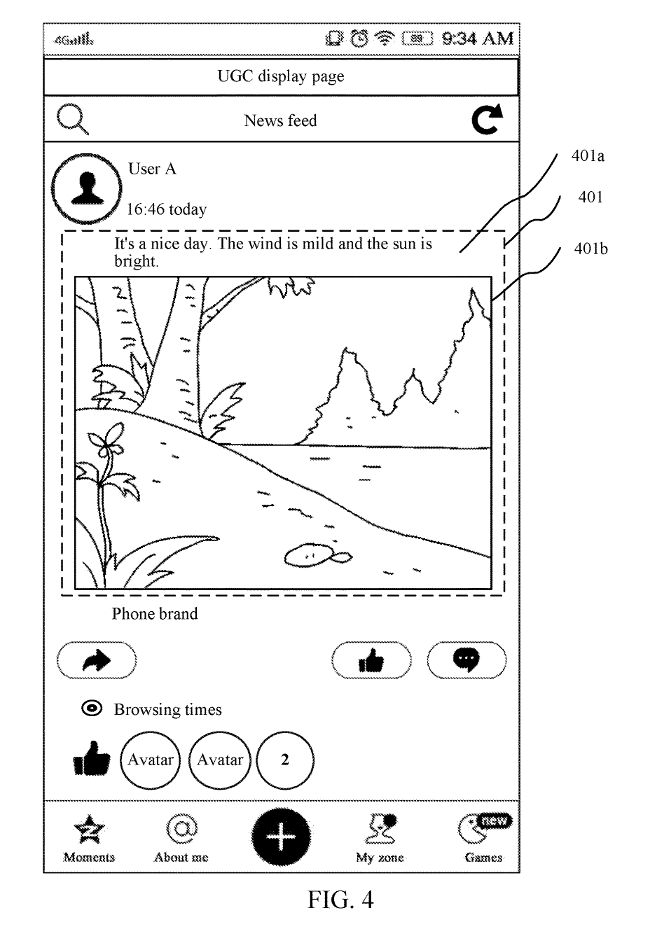

As shown in FIG. 3, in an embodiment, a method for providing feedback on UGC is provided. In this embodiment, description is made by using that the method is applied to the terminal 102a in FIG. 1 as an example. The method specifically includes the following steps.

Step 302: Displaying UGC provided by a social-network friend.

Specifically, the UGC is an abbreviation of User Generated Content, representing content generated by a user. The UGC provided by the social-network friend herein may be original UGC of the social-network friend, or may be original UGC of another user that is shared by the social-network friend.

In an embodiment, the UGC includes at least one of a text, a picture, a video, and audio. For example, with reference to FIG. 4, the terminal 102a displays UGC 401 provided by the social-network friend. The UGC 401 includes UGC 401a in a text form and UGC 401b in a picture form.

The terminal 102a logs in to the server 104 by using a user identifier, and may pull from the server 104 the UGC transferred by the social-network friend having a social-network friend relationship with the user identifier and display the UGC. The user identifier is the only character string or form of ID that identifies the user, and may include at least one of digits, letters, and punctuation marks. In an embodiment, if the terminal 102a caches the UGC of the social-network friend and the UGC does not expire, the cached UGC may be directly displayed.

In an embodiment, when entering a UGC display page, the terminal 102a may pull from the server 104 the UGC of the social-network friend having a social-network relationship with the user identifier and display the UGC. In an embodiment, when entering, as a visitor, a personal page of the social-network friend having the social-network relationship with the user identifier, the terminal 102a may pull from the server 104 the UGC of the social-network friend and display the UGC.

The social-network friend is a data object mapped in a social network by the user, and represents a user that has a social-network relationship with the user that currently logs in to the terminal 102a. The social-network friend herein may be a friend, a colleague, a relative, or a partner of the user that currently logs in to the terminal 102a. The UGC is a set of meaningful information generated by the user, and can be operated as an integral entity.

Step 304: Detecting a starting time-point of a continuous operation on the displayed UGC.

Specifically, the continuous operation refers to an operation continuously acting on the UGC, including at least one of an operation of cursor clicking and holding, an operation of touching and keeping the touch pint, an operation of touching and sliding the touch point, and an operation of long-pressing a physical key. The starting time-point of the operation refers to a time point when the continuous operation starts. The continuous operation performed on the displayed UGC may be a continuous operation that is directly performed on an area in which the displayed UGC is located, or may be a continuous operation that is performed on a particular control corresponding to the displayed UGC.

Step 306: Counting time from the starting time-point of the operation to obtain a timing duration in real-time.

Specifically, after detecting the continuous operation, the terminal 102a uses the detected starting time-point of the continuous operation as the starting time-point of the operation, i.e., time zero, so as to start counting the time to obtain the timing duration in real-time. As time passes, the timing duration keeps increasing.

Step 308: Displaying or playing a sequence of quantified feedback images changing with the increasing timing duration, until the playing of the sequence of the quantified feedback images is completed or the continuous operation ends.

Specifically, the sequence of the quantified feedback images is an image sequence of a preset number of quantified feedback images arranged in order. The quantified feedback images refer to images that quantify feedback and that are represented in a form of images. Quantification of the feedback is to divide the feedback into different levels, and different levels represent different quantified feedback, respectively.

In an embodiment, the feedback includes at least one of positive feedback and negative feedback. The positive feedback indicates that the user gives a positive comment on the UGC provided by the social-network friend, for example, “like”, “support”, or “agree”. The negative feedback indicates that the user gives a negative comment on the UGC provided by the social-network friend, for example, “despise”, “object”, or “disagree”.

The quantification of the feedback in the quantified feedback image may be at least one of character quantification, shape size quantification, shape moving frequency quantification, and time progress quantification.

Specifically, the character quantification may include quantifying by using digits or numbers. For example, integers from 1 to 5 indicate that the feedback is quantified into corresponding five levels. Alternatively, the character quantification may also include quantifying by using English or Chinese characters. For example, five words “not too bad”, “ordinary”, “ok”, “good”, and “very good” indicate that the feedback is quantified into corresponding five levels.

The shape size quantification may refer to representing the level of the feedback by using the size of a particular shape. For example, the different sizes represent corresponding different levels. The shape moving frequency quantification may refer to representing the level of the feedback by using the moving frequency of a particular shape. For example, the different moving frequencies represent corresponding levels. The particular shape may be a gesture shape of thumb-up that indicates like, or may be at least one of a heart shape, a circular shape, a polygonal shape, and an irregular shape.

The time progress quantification may refer to quantifying the level of the feedback according to the time progress. For example, the timing duration of one second is a quantification level, and the timing duration of two seconds is another quantification level. The rest can be deduced by analogy.

Further, playing the sequence of the quantified feedback images is to display the corresponding quantified feedback images one by one according to a sequence. Moreover, a new page is refreshed when a next quantified feedback image is displayed. In this way, only one quantified feedback image in the sequence is displayed at one time. Thus, a dynamic quantified feedback animation may be formed by playing the sequence of the quantified feedback images.

The quantified feedback images in the sequence of the quantified feedback images change as the timing duration increases. In this way, during the playback, a currently played quantified feedback image matches the current timing duration. As time passes, the timing duration keeps increasing and, thus, the currently played quantified feedback image changes constantly.

In an embodiment, a quantification level in the played sequence of the quantified feedback images rises as the timing duration increases. When the playing of the sequence of the quantified feedback images is completed, it indicates that a maximal quantification level of the feedback is reached.

Step 310: Generating quantified feedback information matching the quantified feedback image displayed at the time when the playing is completed or the continuous operation ends, and notifying the terminal logged in by the social-network friend providing the UGC.

Specifically, when the playing of the sequence of the quantified feedback images is completed, a last quantification level of the sequence is reached, and the quantified feedback information corresponding to the last quantification level is generated. When the continuous operation ends, a quantification level that needs to be expressed by the user is achieved and quantified feedback information at a corresponding quantification level is generated. The terminal 102a may notify, through the server 104, the terminal 102b of the generated quantified feedback information.

The quantified feedback information includes at least the quantification level of the feedback, and may also include a preset descriptive sentence corresponding to the quantification level. For example, the quantified information may be “like for three seconds”, or may be “if you ask me how much I love you, like most represents my heart”, or may be “like most is the absolute principle”. “Like most” is a corresponding quantification level for the feedback when the playing of the sequence of the quantified feedback images is completed, or may be a quantification level for the feedback when the timing duration reaches five seconds. “Like most” indicates a strong praise. In an embodiment, the quantified feedback information includes the quantification level for the feedback and corresponding user-defined description information.

In an embodiment, when the playing of the sequence of the quantified feedback images is completed or the continuous operation ends, the terminal 102a may play an animation that the quantified feedback images disappear. Specifically, when the playing is completed or the continuous operation ends, the quantified feedback image may gradually become transparent until it is completely transparent. When the playing is completed or the continuous operation ends, before or during the process that the quantified feedback image gradually become completely transparent, the terminal 102a may move up the quantified feedback image displayed when the playing is completed or the continuous operation ends as a preset example.

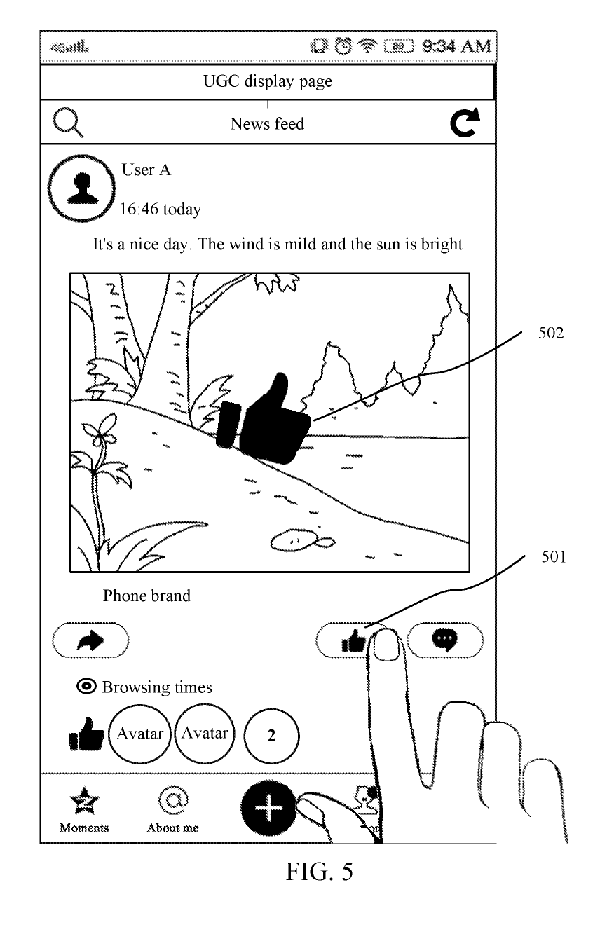

For example, with reference to FIG. 5, the user long presses a positive feedback control 501, and the terminal 102a displays, at a center of a UGC display area or a center of the display screen, a first quantified feedback image 502 in the sequence of the quantified feedback images.

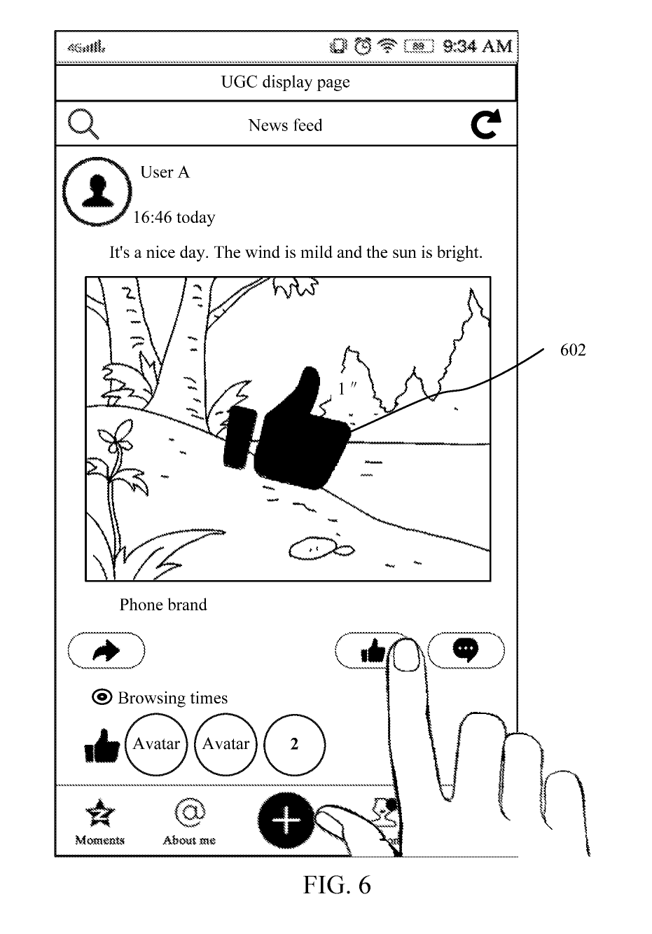

With reference to FIG. 6, when the user long presses the positive feedback control 501 for one second, the terminal 102a displays a quantified feedback image 602. The quantified feedback image 602 includes the timing duration of one second. Moreover, a gesture shape of thumbs up in the quantified feedback image 602 has a larger size as compared with the gesture shape of thumbs up in the quantified feedback image 502.

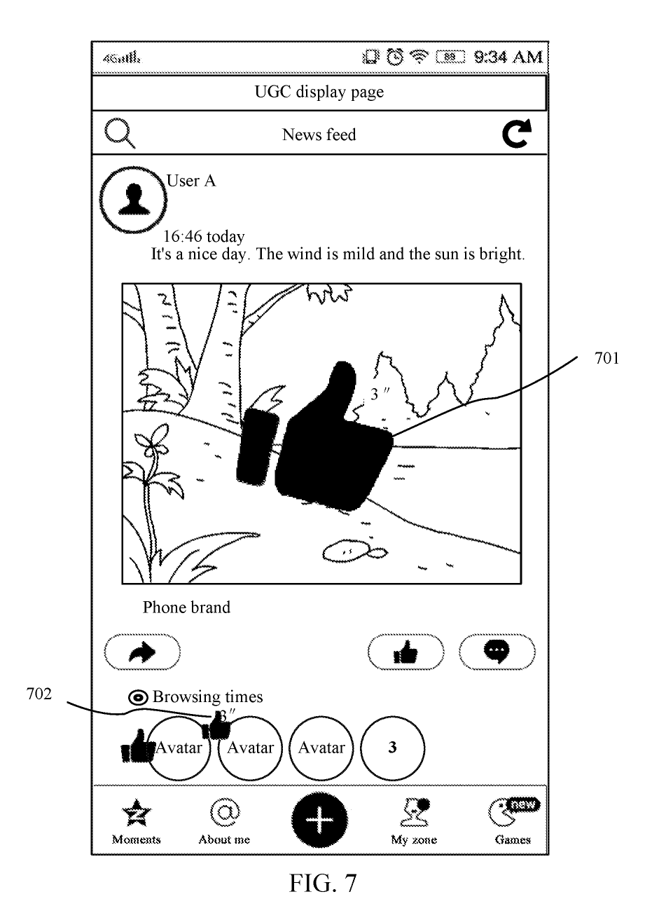

With reference to FIG. 7, the user long keeps long pressing the positive feedback control 501. If long pressing is stopped when duration reaches three to four seconds (not include four seconds), the terminal 102a may display a quantified feedback image 701. The quantified feedback image 701 includes the timing duration of three seconds. Moreover, a gesture shape of thumbs up in the quantified feedback image 701 has a larger size as compared with the gesture shape of thumbs up in the quantified feedback image 602.

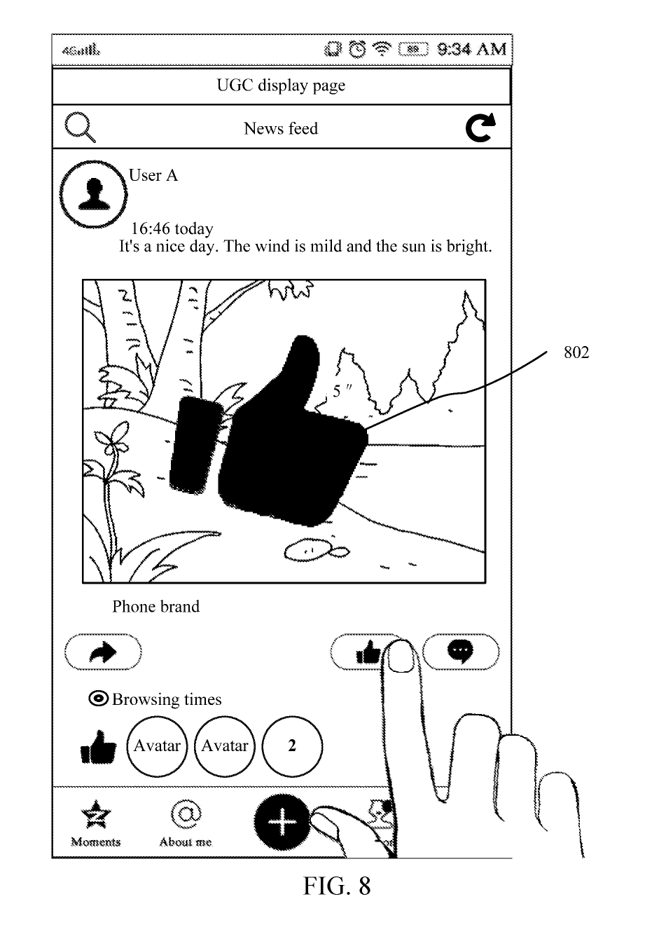

With reference to FIG. 8, if the user long keeps long pressing the positive feedback control 501 until the playing of the sequence of quantified feedback images is completed, or the duration of the continuous operation of the UGC reaches five seconds, a highest quantification level “like most” 802 is reached at this time. It indicates that the user has a supreme comment on the UGC. In this way the quantified feedback image, when the playing is completed or the continuous operation ends, may include timing duration of five seconds, and a size a gesture shape of thumbs up reaches the largest.

According to the foregoing method for providing feedback on UGC, UGC provided by a social-network friend is displayed. In this way, when a user performs a continuous operation on the displayed UGC, a timing duration in real-time is obtained by counting time from the starting time-point of the continuous operation. Therefore, feedback intention at different levels of the user for the UGC may be reflected. Playing the sequence of the quantified feedback images that vary as the timing duration increases may enable the user to intuitively determine a quantification level of feedback made by the user. When the playing of the sequence of the quantified feedback images is completed or the continuous operation ends, corresponding quantified feedback information may be generated and a terminal logged in by the social-network friend may be notified. In this way, a party that provides feedback on the UGC may generate different quantified feedback information by adjusting duration of a continuous operation. The different quantified feedback information reflects the feedback intention at different levels of the user. Thus, the amount of the information carried by the quantified feedback information is increased, and a party providing the UGC may obtain more information through the quantified feedback information. Therefore, a larger amount of information can be transferred, facilitating hierarchical expressions of emotions between users.

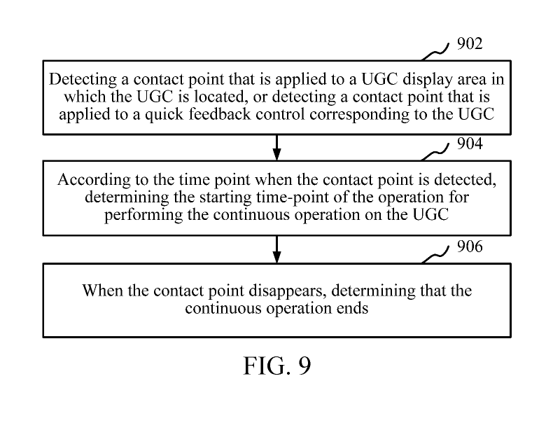

As shown in FIG. 9, in an embodiment, step 304 in FIG. 3 may specifically include the followings.

Step 902: Detecting a contact point that is applied to a UGC display area in which the UGC is located, or detecting a contact point that is applied to a quick feedback control corresponding to the UGC. The quick feedback control includes at least one of a positive quick feedback control and a negative quick feedback control.

Specifically, the UGC display area is the area is used to display UGC. The terminal 102a may detect a contact point that is applied to any position in the UGC display area. The terminal 102a may further display the quick feedback control corresponding to the displayed UGC, so as to detect the contact point of the quick feedback control. The contact point may be a touch point or a cursor clicking point.

The quick feedback control is configured to trigger feedback information. When clicked, the quick feedback control is configured to trigger non-quantitative feedback information; and when continuously applied, the quick feedback control is configured to trigger the quantified feedback information. When continuously triggered, the positive quick feedback control is configured to trigger positive quantified feedback information, for example, “like”, “support”, or “agree”. When continuously triggered, the negative quick feedback control is configured to trigger negative quantified feedback information, for example, “despise”, “object”, or “disagree”. The UGC display page shown in FIG. 5 displays a positive quick feedback control 501.

Step 904: According to the time point when the contact point is detected, determining the starting time-point of the operation for performing the continuous operation on the UGC.

In an embodiment, the terminal 102a may use the time point when the contact point is detected as the starting time-point of the operation for performing the continuous operation on the UGC. In an embodiment, after the contact point is detected and the contact point lasts for a preset time interval, the terminal 102a uses the time point when the contact point is detected as the starting time-point of the operation. The preset time interval herein is a maximal applying time length of a single click. Reaching the preset time interval indicates that an operation of the contact point is not a single click operation but is a continuous operation. In this way, both conventional quick feedback format with a single can be compatible.

Step 906: When the contact point disappears, determining that the continuous operation ends.

Specifically, for example, when a finger of the user touches a touchscreen of the terminal 102a, the terminal 102a detects a contact point in a form of a touch point. The contact point disappears when the finger of the user leaves the touchscreen. When the user controls continuous clicking of the cursor by using a mouse, a physical key, or a virtual keyboard, the terminal 102a detects a contact point in a form of a cursor clicking point. The contact point disappears when the continuous cursor clicking ends. The terminal 102a determines, when the contact point disappears, that the continuous operation ends, so as to perform step 310 (FIG. 3). The duration of the continuous operation is from the starting time-point of the operation to the time point when the continuous operation ends.

In this embodiment, the starting time-point of the continuous operation may be determined according to a position at which the contact point is detected and a time when the contact point is detected. Therefore, timing may be performed and the time point when the continuous operation ends may be detected. Thus, quantified feedback may be made to the UGC conveniently, so as to facilitate the operation.

In an embodiment, playing a sequence of quantified feedback images that vary as the timing duration increases in step 308 may be achieved in multiple ways, as described below. It can be understood that the multiple ways below may be freely combined.

In an embodiment, playing a sequence of quantified feedback images that vary as the timing duration increases includes: playing a sequence of quantified feedback images whose sizes are correspondingly enlarged as the timing duration increases.

Specifically, during a process of playing the sequence of the quantified feedback images, sizes of particular shapes of the quantified feedback images are enlarged as the timing duration increases. For example, with reference to FIG. 5 to FIG. 7, a size of the gesture shape of thumbs up becomes larger as the timing duration increases.

In an embodiment, playing a sequence of quantified feedback images that vary as the timing duration increases includes: playing a sequence of quantified feedback images that shake at a correspondingly increased frequency as the timing duration increases.

Specifically, during a process of playing the sequence of the quantified feedback images, particular shapes of the quantified feedback images shake, and a shaking frequency is increased as the timing duration increases. For example, with reference to FIG. 5 to FIG. 7, the gesture of thumbs up can shake continuously at a low frequency, and shake faster as the timing duration increases.

In an embodiment, playing a sequence of quantified feedback images that vary as the timing duration increases includes: playing a sequence of quantified feedback images that have a fillable area and the filled portion of the fillable area correspondingly increases as the timing duration increases.

Specifically, the fillable area refers to an area that can be filled by colors, pictures, or patterns. The fillable area is blank at an initial time, and is constantly filled as the timing duration increases. In this way, the area of the filled portion in the fillable area is constantly increased.

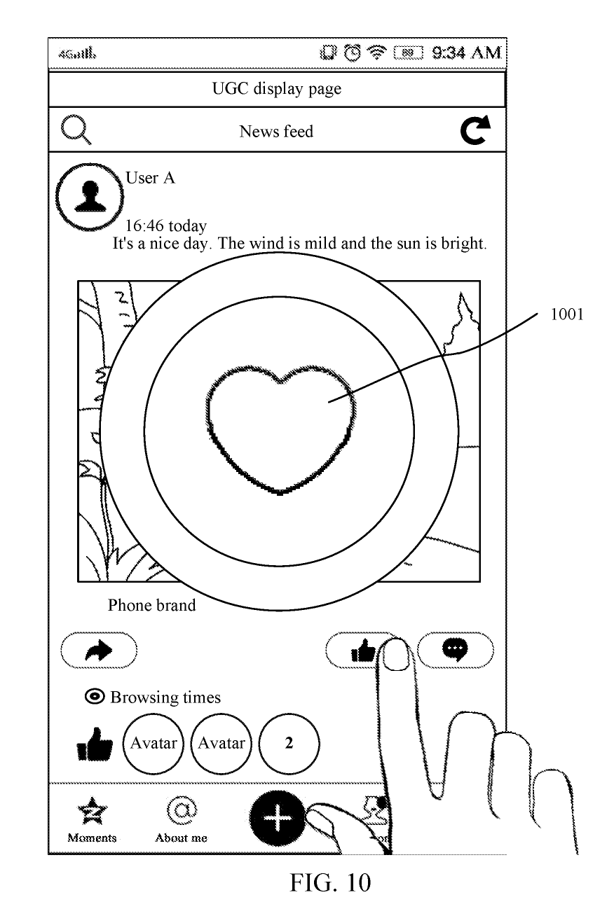

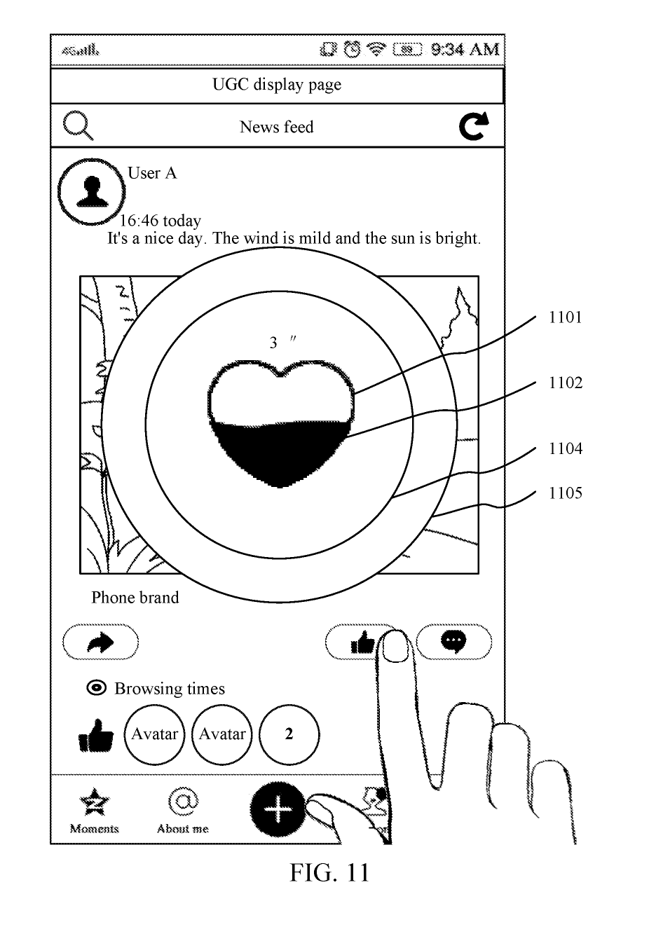

For example, with reference to FIG. 10 and FIG. 11, the quantified feedback to image has a blank fillable area 1001 (a heart shape). As the timing duration increases, the fillable area 1001 is filled from a bottom portion thereof. When the timing duration reaches three seconds, a portion of the fillable area 1001 becomes a filled area 1102. As the timing duration constantly increases, an area of the filled area 1102 still becomes larger.

In an embodiment, playing a sequence of quantified feedback images that vary as the timing duration increases includes: playing a sequence of quantified feedback images having characters that represent increase progress of the timing duration.

Specifically, during the process of playing the sequence of the quantified feedback images, the quantified feedback images include characters that are used to represent the increase progress of the timing duration. The characters vary accordingly as the timing duration increases. For example, with reference to FIG. 11, “3” is displayed above fillable area 1101 when the timing duration reaches three seconds, and it indicates that the current timing duration is greater than three seconds and is smaller than four seconds.

In an embodiment, playing a sequence of quantified feedback images that vary as the timing duration increases includes: playing a sequence of quantified feedback images that periodically vary every time when the timing duration reaches an integer.

Specifically, during the process of playing the sequence of the quantified feedback images, every time when the timing duration reaches an integer, for example, one second, two seconds, and three seconds, the quantified feedback images in the sequence of the quantified feedback images may periodically vary. Varying periodically indicates that changes in two different entire periods are the same. Cycle for varying periodically may be greater than, equal to, or smaller than an interval between adjacent integers of the timing duration.

For example, with reference to FIG. 11, every time when the timing duration reaches an integer, a circle 1104 of a preset diameter that uses the fillable area 1001 as a center appears, and moves by increasing the diameter, so as to form a new circle 1105. A time when the circle 1105 is achieved may be a time when or after next timing reaches an integer.

In the foregoing embodiments, multiple implementations of the playing a sequence of quantified feedback images that vary as timing duration increases are provided. Therefore, a user can intuitively determine a quantification level of feedback being made by the user, so as to conveniently and accurately determine quantified feedback information.

In an embodiment, the method for providing feedback on UGC further includes: in a preset area using the played quantified feedback images as a center, playing an animation that an image element moves as the timing duration increases, until the playing of the sequence of the quantified feedback images is completed; and then playing an animation that the image element in the preset area using the played quantified feedback images as the center diffuses outward the preset area.

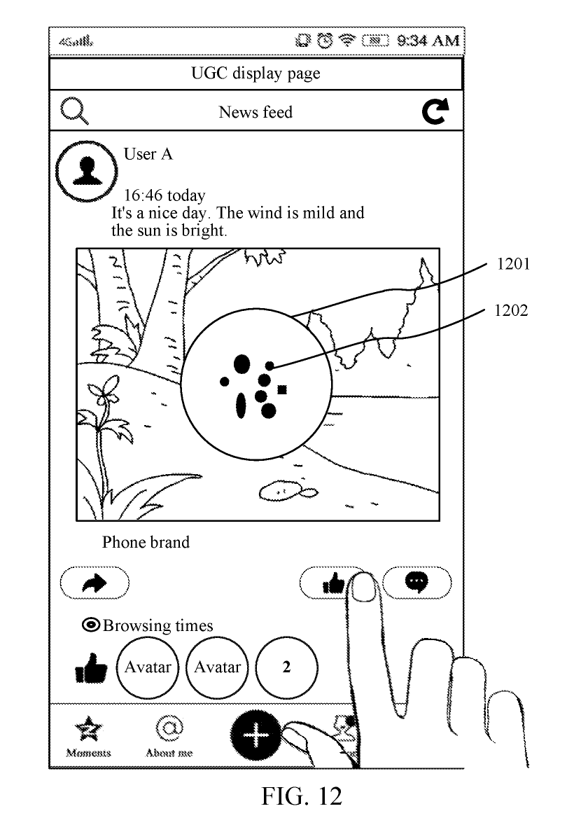

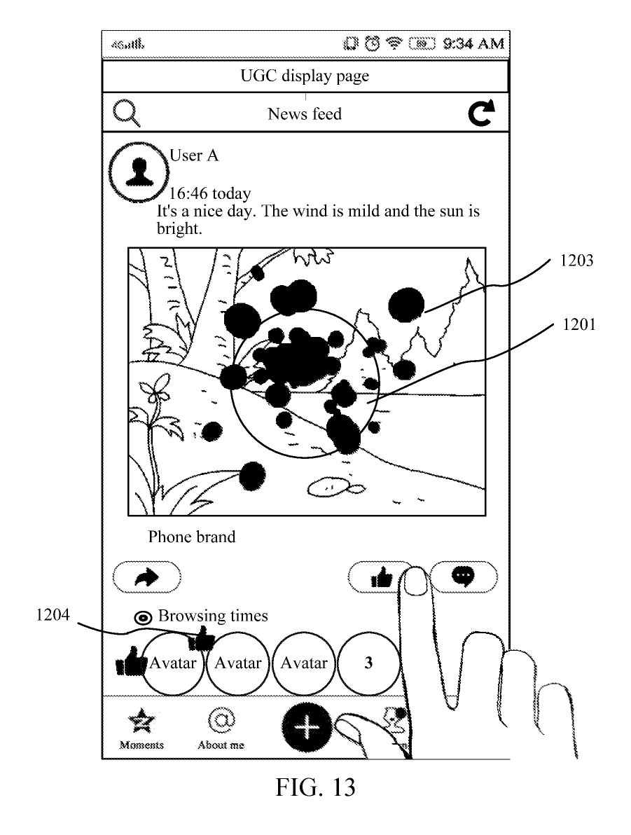

Specifically, with reference to FIG. 12 and FIG. 13, to explicitly show a preset area 1201, an image element 1202, and an image element 1203, the gesture shape of thumbs up is omitted in FIG. 12 and FIG. 13. The terminal 102a plays the sequence of the quantified feedback images that vary as the timing duration increases, and plays an animation that the image element moves as the timing duration increases at the same time. The image element herein refers to some small-size images whose shapes are smaller than a main shape (for example, the gesture shape of thumbs up) in the quantified feedback images.

As the timing duration increases, the image element 1202 in the animation that is being played moves within the preset area 1201. For example, the image element 1202 diffuses gradually from a particular area in the preset area to another area in the preset area, and disappears when diffuses to a degree. Playing of the animation is stopped until the timing duration reaches preset duration or the continuous operation ends. The terminal 102a may further play an animation that the image element 1203 in the preset area 1201 diffuses outward the preset area 1201.

In this embodiment, whether playing of the sequence of the quantified feedback images is completed may be clearly learned through the two segments of animations, so as to prompt the user that feedback of quantification of the user reaches a final level and cannot be modified again. Therefore, the user may be prompted to avoid an operation of remaining the continuous operation again, thereby saving the operation time and facilitating the operation.

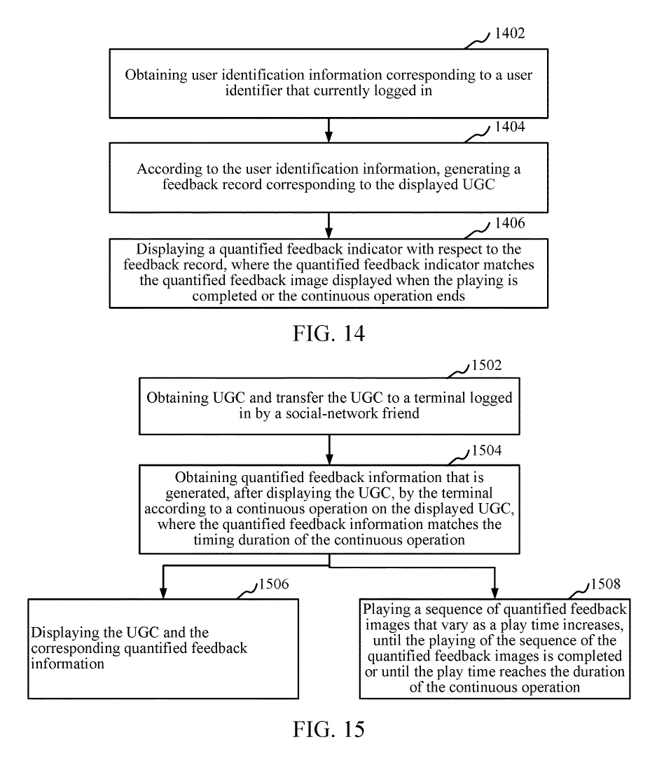

As shown in FIG. 14, in an embodiment, the method for providing feedback on UGC further includes generating a feedback record, specifically including the followings.

Step 1402: Obtaining user identification information corresponding to a user identifier that currently logged in.

Specifically, the terminal 102a obtains the user identification information corresponding to the user identifier that currently logs in to a social application. The user identification information refers to information that can identify the user to some extent. In an embodiment, the user identification information includes at least one of a user avatar, a user name, and a user alias.

Step 1404: According to the user identification information, generating a feedback record corresponding to the displayed UGC.

Specifically, the feedback record corresponds to the displayed UGC, and is used to represent a historical record that a user provided feedback on the corresponding UGC. The feedback record is generated according to the user identification information. Specifically, the feedback record may include the user identification information or include a portion of the user identification information.

Step 1406: Displaying a quantified feedback indicator with respect to the feedback record, where the quantified feedback indicator matches the quantified feedback image displayed when the playing is completed or the continuous operation ends.

Specifically, the quantified feedback indicator matches the quantified feedback image displayed when the playing is completed or the continuous operation ends, and corresponds to the feedback record. The feedback record is used to indicate a level to which the feedback information is quantified. The quantified feedback indicator may be represented by a character or a pattern that indicates a quantification level.

For example, with reference to FIG. 7, after the quantified feedback information is generated, the user avatar of the user that currently logs in may be obtained. The user avatar is used as the feedback record, and a quantified feedback indicator 702 is shown at an upper right corner of the user avatar. The quantified feedback indicator 702 matches the quantified feedback image 701. Further for example, in FIG. 13, a quantified feedback indicator 1204 at the upper right corner of the user avatar matches the quantified feedback image that is at a time when the playing of the sequence is completed, and indicates “like most”. It can be understood that the quantified feedback indicator may be displayed at the upper right corner of the user avatar to represent a correspondence between the user avatar, or may be displayed at other positions, for example, below or above the user avatar.

In the embodiment, a feedback record is generated according to user identification information, so that a quantified feedback indicator is displayed regarding the feedback record. Therefore, the user can intuitively obtain a feedback result of other users for the UGC, so as to provide reference for the quantified feedback of the user. As a result, abilities for multiple users to interact are improved.

As shown in FIG. 15, in an embodiment, a method for displaying feedback information is provided. In the embodiment, the method is applied to the terminal 102b in FIG. 1, as an example. The method specifically includes the followings.

Step 1502: Obtaining UGC and transfer the UGC to a terminal logged in by a social-network friend.

Specifically, the terminal 102b may instantly obtain the UGC and transfer the UGC to the terminal 102a logged in by the social-network friend corresponding to a user identifier that currently logs in. For example, the terminal 102b may take a photo or enter a text on the spot. The terminal 102b may also select from a local content to obtain the UGC and transfer the UGC to the terminal 102a logged in by the social-network friend corresponding to the user identifier that currently logs in. For example, the terminal 102b may obtain one or more pictures from a local album. The terminal 102b may also obtain the UGC from a server and transfer the UGC to the terminal 102a logged in by the social-network friend corresponding to the user identifier that currently logs in. The UGC may be transferred to one, multiple, or all social-network friends having social-network relationships with the user identifier that currently logs in.

Step 1504: Obtaining quantified feedback information that is generated, after displaying the UGC, by the terminal according to a continuous operation on the displayed UGC, where the quantified feedback information matches the timing duration of the continuous operation.

Specifically, reference may be made to the embodiments of the foregoing method for providing feedback on UGC. The terminal 102a may display the UGC transferred by the terminal 102b; detect a starting time-point of operation for performing the continuous operation on the displayed UGC; count time from the starting time-point of the operation to obtain a timing duration in real-time; play a sequence of quantified feedback images that vary as the timing duration increases, until the playing of the sequence of the quantified feedback images is completed or the continuous operation ends; and generate quantified feedback information matching the quantified feedback image displayed when playing is completed or the continuous operation ends, and notifies the terminal 102b. The duration of the continuous operation is from the starting time-point of the operation to the time point when the continuous operation ends.

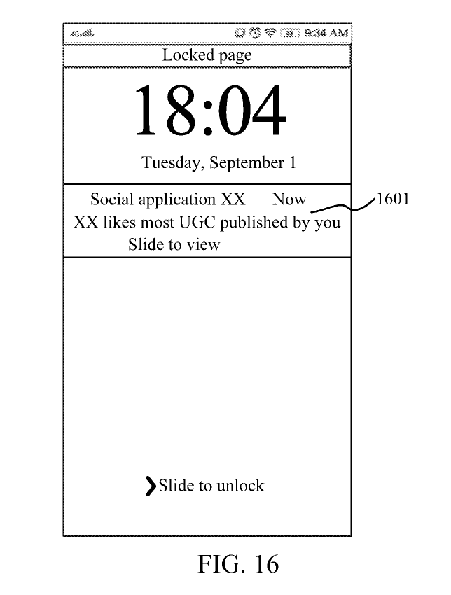

After receiving the notification from the terminal 102a, the terminal 102b may display, for example, in a system notification bar shown in FIG. 16, a prompt 1601 that quantified feedback of the transferred UGC is triggered to generate the quantified feedback information. The terminal 102b triggers subsequent steps that include Step 1506 after detecting an operation for this prompt. The operation herein is, for example, click or touch and slide.

Step 1506: Displaying the UGC and the corresponding quantified feedback information.

Specifically, as a host, the terminal 102b may enter a personal page corresponding to the user identifier currently login, and display the UGC and the quantified feedback information corresponding to the social-network friend. The quantified feedback information may be directly displayed, or only a quantification level for feedback in the quantified feedback information is displayed, or information including further processing of the quantification level for feedback in the quantified feedback information is displayed.

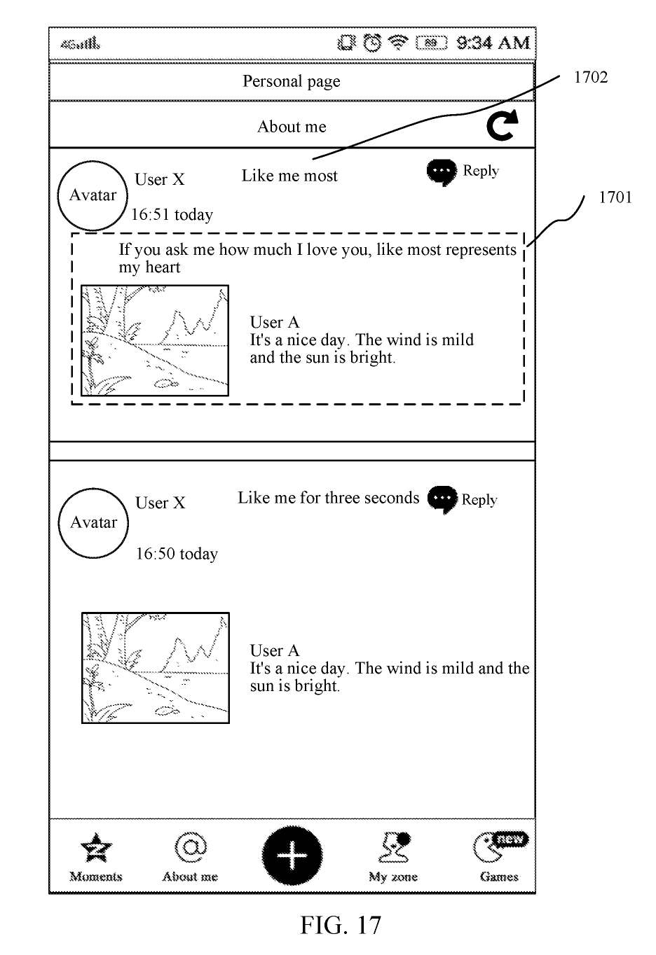

For example, with reference to FIG. 17, the user may click “about me” to enter the personal page as a host, and may display in the personal page the UGC and the corresponding quantified feedback information in a reverse order of publishing time. Specifically, the terminal 102b may display UGC 1701 and processed quantified feedback information 1702 in the personal page.

Step 1508: Playing a sequence of quantified feedback images that vary as a play time increases, until the playing of the sequence of the quantified feedback images is completed or until the play time reaches the duration of the continuous operation.

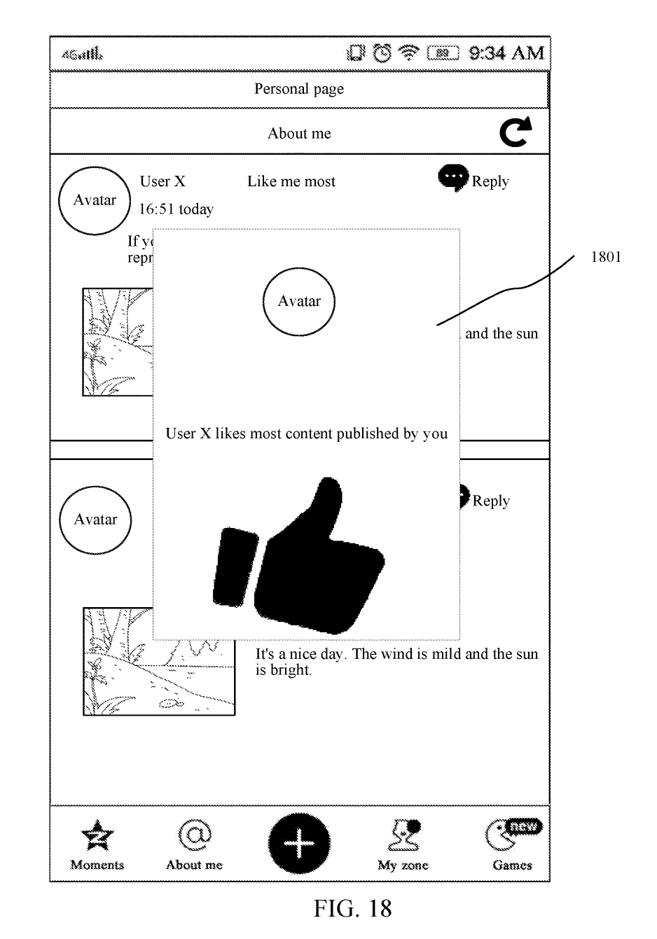

Specifically, with reference to FIG. 18, when the terminal 102b visits the personal page as a host, a floating layer 1801 may be displayed on the personal page. The sequence of the quantified feedback images that vary as the play time increases is played on the floating layer until the playing of the sequence of the quantified feedback images is completed, or the playing is stopped until the play time reaches the duration of the continuous operation. The floating layer is turned off when the playing is completed. The floating layer is a layer that may cover other images and may be turned off. In an embodiment, step 1508 may be performed before step 1506, or may be performed after step 1506.

According to the foregoing method for displaying feedback information, after the UGC is transferred to a terminal logged in by the social-network friend, the terminal displays the UGC, and generates corresponding quantified feedback information according to the continuous operation for the displayed UGC. The duration of the continuous operation may reflect feedback intention at different levels of the user for the UGC. The corresponding generated quantified feedback information may reflect the feedback intention at different levels of the user. In this way, a party that provides feedback on the UGC may generate different quantified feedback information by adjusting duration of the continuous operation. The different quantified feedback information reflects the feedback intention at different levels of the user. An amount of information carried by the quantified feedback information is increased, and a party providing the UGC may obtain more information through the quantified feedback information. Therefore, a larger amount of information can be transferred.

In an embodiment, a contact point of the continuous operation is applied to a UGC display area in which the UGC is located, or is applied to a quick feedback control corresponding to the UGC. The quick feedback control includes at least one of a positive quick feedback control and a negative quick feedback control.

Specifically, the UGC display area in which the UGC is located is used to display a UGC area. The terminal 102a may detect a contact point that is applied to any position in the UGC display area. The terminal 102a may further display the quick feedback control corresponding to the displayed UGC, so as to detect the contact point of the quick feedback control. The contact point may be a touch point or a cursor clicking point.

The quick feedback control is configured to trigger feedback information. When clicked, the quick feedback control is configured to trigger conventional non-quantitative feedback information; and when continuously triggered, the quick feedback control is configured to trigger the quantified feedback information. When continuously triggered, the positive quick feedback control is configured to trigger positive quantified feedback information, for example, “like”, “support”, or “agree”. When continuously triggered, the negative quick feedback control is configured to trigger negative quantified feedback information, for example, “despise”, “object′”, or “disagree”.

In this embodiment, the starting time-point of the continuous operation may be determined according to a position at which the contact point is detected and a time when the contact point is detected. Therefore, timing may be performed and a time point when the continuous operation ends may be detected. As a result, quantified feedback may be made to the UGC conveniently, so as to facilitate the operation.

In an embodiment, playing a sequence of quantified feedback images that vary as a play time increases may be achieved in multiple ways, as described below. It can be understood that the multiple ways below may be freely combined.

In an embodiment, playing a sequence of quantified feedback images that vary as a play time increases includes: playing a sequence of quantified feedback images whose sizes are correspondingly enlarged as the play time increases. Specifically, during a process of playing the sequence of the quantified feedback images, sizes of particular shapes of the quantified feedback images are enlarged as the play time increases.

In an embodiment, playing a sequence of quantified feedback images that vary as a timing duration increases includes: playing a sequence of quantified feedback images that shake at a correspondingly increased frequency as the play time increases. Specifically, during a process of playing the sequence of the quantified feedback images, particular shapes of the quantified feedback images shake, and a shaking frequency is increased as the play time increases.

In an embodiment, playing a sequence of quantified feedback images that vary as a timing duration increases includes: playing a sequence of quantified feedback images that have a fillable area and the filled portion in the fillable area correspondingly increases as the play time increases. Specifically, the fillable area refers to an area that can be filled by colors, pictures, or patterns. The fillable area is blank at an initial time, and is constantly filled as the play time increases. In this way, the area of the filled portion in the fillable area is constantly increased.

In an embodiment, playing a sequence of quantified feedback images that vary as a play time increases includes: playing a sequence of quantified feedback images having characters that represent increase progress of the play time. Specifically, during the process of playing the sequence of the quantified feedback images, the quantified feedback images include characters that are used to represent the increase progress of the play time. The characters vary accordingly as the play time increases.

In an embodiment, playing a sequence of quantified feedback images that vary as a play time increases includes: playing a sequence of quantified feedback images that periodically vary every time when the play time reaches an integer. Specifically, during the process of playing the sequence of the quantified feedback images, every time when the play time reaches an integer, for example, one second, two seconds, and three seconds, the quantified feedback images in the sequence of the quantified feedback images may periodically vary. Varying periodically indicates that changes in two different entire periods are the same. Cycle for varying periodically may be greater than, equal to, or smaller than an interval between adjacent integers of the play time.

In the foregoing embodiments, multiple implementations of the playing a sequence of quantified feedback images that vary as a play time increases are provided. Therefore, a user can intuitively reproduce a quantification level of feedback made by a terminal 102a, so as to transfer more information.

In an embodiment, the method for displaying feedback information further includes: in a preset area using the played quantified feedback images as a center, playing an animation that moves as the play time increases, until the playing of the sequence of the quantified feedback images is completed; and playing an animation that an image element in the preset area using the played quantified feedback images as the center diffuses outward the preset area.

In this embodiment, whether the playing of the sequence of the quantified feedback images is completed may be clearly learned through the two segments of animations, so as to prompt the user that feedback of quantification of the user reaches a final level. The user may intuitively know play progress, and transfer more information, thereby facilitating hierarchical expressions of emotions between users.

In an embodiment, the method for displaying feedback information further includes: displaying a feedback record corresponding to the UGC, where the feedback record is generated according to user identification information of the social-network friend; and displaying a quantified feedback indicator with respect to the feedback record, where the quantified feedback indicator matches the duration of the continuous operation.

Specifically, the user identification information refers to information that can identify the user to some extent. In an embodiment, the user identification information includes at least one of a user avatar, a user name, and a user alias. The feedback record corresponds to the displayed UGC, and is used to represent a historical record that a user provided feedback on the corresponding UGC. The feedback record is generated according to the user identification information. Specifically, the feedback record may include the user identification information or include a portion of the user identification information. The feedback record is used to indicate a level to which the feedback information is quantified. The quantified feedback indicator may be represented by a character or a pattern that indicates a quantification level.

In this embodiment, a feedback record is generated, so that a quantified feedback indicator is displayed regarding the feedback record. Therefore, the user can intuitively obtain a feedback result of other users for the UGC, so as to provide reference for the quantified feedback of the user. Thus, abilities for multiple users to interact are improved.

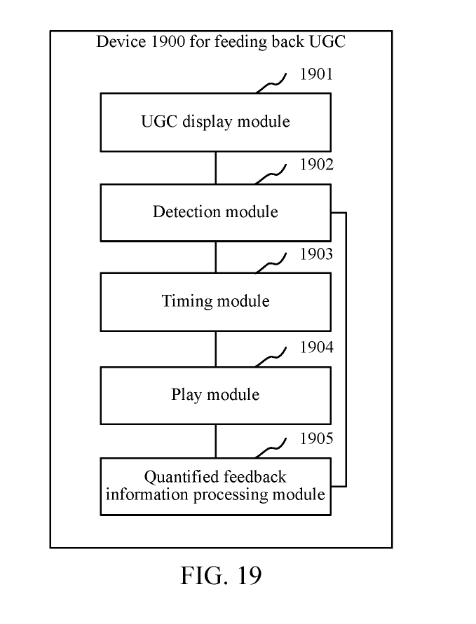

As shown in FIG. 19, in an embodiment, a device 1900 for providing feedback on UGC is provided. The device has functional modules for implementing the method for providing feedback on UGC in the foregoing embodiments. The device 1900 for providing feedback on UGC includes: a UGC display module 1901, a detection module 1902, a timing module 1903, a play module 1904, and a quantified feedback information processing module 1905.

The UGC display module 1901 is configured to display the UGC provided by a social-network friend.

The detection module 1902 is configured to detect a starting time-point of operation for performing a continuous operation on the displayed UGC.

The timing module 1903 is configured to count time from the starting time-point of the operation to obtain a timing duration in real-time.

The play module 1904 is configured to play a sequence of quantified feedback images that vary as the timing duration increases, until the playing of the sequence of the quantified feedback images is completed or the continuous operation ends.

The quantified feedback information processing module 1905 is configured to generate quantified feedback information matching the quantified feedback image displayed when playing is completed or the continuous operation ends, and notify a terminal logged in by the social-network friend.

In an embodiment, the detection module 1902 is specifically configured to detect a contact point that is applied to a UGC display area in which the UGC is located, or detect a contact point that is applied to a quick feedback control corresponding to the UGC. The quick feedback control includes at least one of a positive quick feedback control and a negative quick feedback control. The starting time-point of the operation for performing the continuous operation on the UGC is determined according to a time point when the contact point is detected. When the contact point disappears, it is determined that the continuous operation ends.

In an embodiment, the play module 1904 is further configured to play a sequence of quantified feedback images whose sizes are correspondingly enlarged as the timing duration increases.

In an embodiment, the play module 1904 is further configured to play a sequence of quantified feedback images that shake at a correspondingly increased frequency as the timing duration increases.

In an embodiment, the play module 1904 is further configured to play a sequence of quantified feedback images that have a fillable area and the filled portion in the fillable area is correspondingly increased as the timing duration increases.

In an embodiment, the play module 1904 is further configured to play a sequence of quantified feedback images having characters that represent increase progress of the timing duration.

In an embodiment, the play module 1904 is further configured to play a sequence of quantified feedback images that periodically vary every time when the timing duration reaches an integer.

In an embodiment, the play module 1904 is further configured to play an animation that an image element in a preset area using the played quantified feedback images as a center moves as the timing duration increases, until the playing of the sequence of the quantified feedback images is completed; and then play an animation that the image element in the preset area using the played quantified feedback images as the center diffuses outward the preset area.

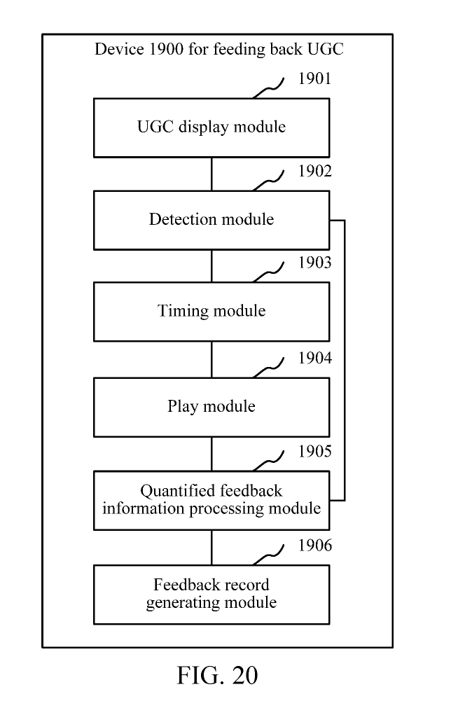

As shown in FIG. 20, in an embodiment, the device 1900 for providing feedback on UGC further includes a feedback record generating module 1906 that is configured to obtain user identification information corresponding to a user identifier that currently logs in; generate, according to the user identification information, a feedback record corresponding to the displayed UGC; and display, regarding the feedback record, a quantified feedback indicator, where the quantified feedback indicator matches the quantified feedback image at a time when the playing is completed or the continuous operation ends.

The foregoing device 1900 for providing feedback on UGC displays UGC provided by a social-network friend. In this way, when a user performs a continuous operation on the displayed UGC, a timing duration in real-time is obtained by counting time from the starting time-point of the continuous operation. Therefore, feedback intention at different levels of the user for the UGC may be reflected. Playing the sequence of the quantified feedback images that vary as the timing duration increases may enable the user to intuitively determine a quantification level of feedback that is to be made by the user. When the playing of the sequence of the quantified feedback images is completed or the continuous operation ends, corresponding quantified feedback information may be generated and a terminal logged in by the social-network friend may be informed. In this way, a party that provides feedback on the UGC may generate different quantified feedback information by adjusting duration of the continuous operation. The different quantified feedback information reflects the feedback intention at different levels of the user. The amount of amount of information carried by the quantified feedback information is increased, and a party providing the UGC may obtain more information through the quantified feedback information. Therefore, a larger amount of information can be transferred.

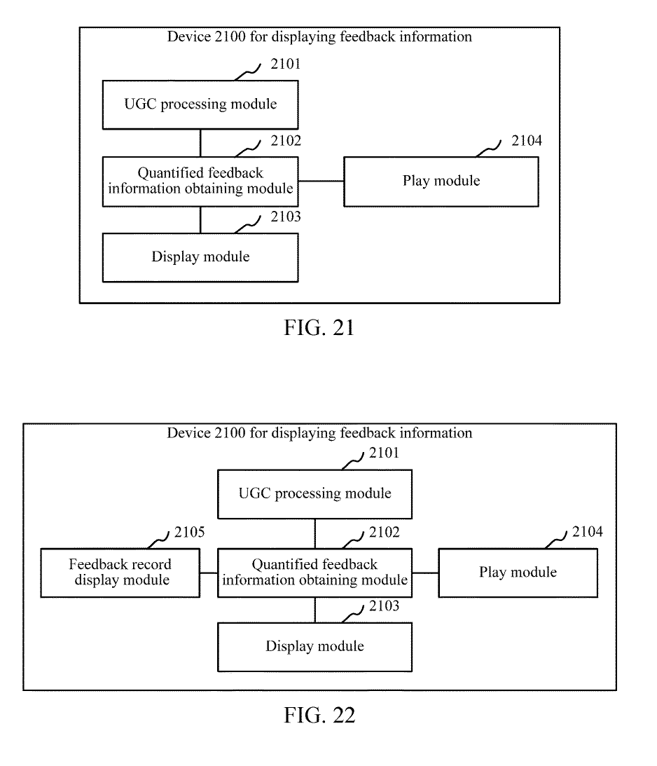

As shown in FIG. 21, in an embodiment, a device 2100 for displaying feedback information is provided. The device has functional modules for implementing the method for displaying feedback information in the foregoing embodiments. The device 2100 for displaying feedback information includes a UGC processing module 2101, a quantified feedback information obtaining module 2102, a display module 2103, and a play module 2104.

The UGC processing module 2101 is configured to obtain UGC and transfer the UGC to a terminal logged in by a social-network friend.

The quantified feedback information obtaining module 2102 is configured to obtain quantified feedback information that is generated, after displaying the UGC, by the terminal according to a continuous operation on the displayed UGC, where the quantified feedback information matches duration of the continuous operation.

The display module 2103 is configured to display the UGC and the corresponding quantified feedback information.

The play module 2104 is configured to play a sequence of quantified feedback images that vary as a play time increases, until the playing of the sequence of the quantified feedback images is completed or until the play time reaches the duration of the continuous operation.

In an embodiment, a contact point of the continuous operation is applied to a UGC display area in which the UGC is located, or is applied to a quick feedback control corresponding to the UGC. The quick feedback control includes at least one of a positive quick feedback control and a negative quick feedback control.

In an embodiment, the play module 2104 is further configured to play a sequence of quantified feedback images whose sizes are correspondingly enlarged as the play time increases.

In an embodiment, the play module 2104 is further configured to play a sequence of quantified feedback images that shake at a correspondingly increased frequency as the play time increases.

In an embodiment, the play module 2104 is further configured to play a sequence of quantified feedback images that have a fillable area and the filled portion in the fillable area is correspondingly increased as the play time increases.

In an embodiment, the play module 2104 is further configured to play a sequence of quantified feedback images having characters that represent increase progress of the play time.

In an embodiment, the play module 2104 is further configured to play a sequence of quantified feedback images that periodically vary every time when the play time reaches an integer.

In an embodiment, the play module 2104 is further configured to play an animation that is in a preset area using the played quantified feedback images as a center and that moves as the play time increases, until the sequence of the quantified feedback images are played; and then play an animation that an image element in the preset area using the played quantified feedback images as the center diffuses outward the preset area.

As shown in FIG. 21, in an embodiment, the device 2100 for displaying feedback information further includes a feedback record display module 2105 that is configured to display a feedback record corresponding to the UGC, where the feedback record is generated according to user identification information of the social-network friend; and display, regarding the feedback record, a corresponding quantified feedback indicator, where the quantified feedback indicator matches the duration of the continuous operation.

After the foregoing device 2100 for displaying feedback information transfers the UGC to a terminal logged in by the social-network friend, the terminal displays the UGC, and generates corresponding quantified feedback information according to the continuous operation for the displayed UGC. The duration of the continuous operation may reflect feedback intention at different levels of the user for the UGC. The corresponding generated quantified feedback information may reflect the feedback intention at different levels of the user. In this way, a party that provides feedback on the UGC may generate different quantified feedback information by adjusting duration of the continuous operation. The different quantified feedback information reflects the feedback intention at different levels of the user. The amount of information carried by the quantified feedback information is increased, and a party providing the UGC may obtain more information through the quantified feedback information. Therefore, a larger amount of information can be transferred.

A person of ordinary skill in the art may understand that all or some of the processes of the methods in the foregoing embodiments may be implemented by computer program instructing relevant hardware. The program may be stored in a computer readable storage medium. When the program runs, the processes of the methods in the foregoing embodiments are performed. The storage medium may be a non-volatile storage medium such as a magnetic disk, an optical disc, or a read-only memory (Read-Only Memory, ROM), or may be a random access memory (Random Access Memory, RAM), or the like.

The technical features of the foregoing embodiments may be freely combined. For a brief description, not all possible combinations of the technical features in the foregoing embodiments are described. However, the combinations of these technical features should be considered to fall within the scope of this specification as long as the combinations are not contradictory.

The foregoing embodiments only describe several implementations of the present disclosure, and their descriptions are specific and detailed, but cannot therefore be understood as a limitation to the patent scope of the present disclosure. It should be noted that a person of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. A method for providing feedback on UGC (user generated content) by a user, comprising:
displaying UGC provided by a social-network friend of the user;
detecting a starting time-point of a continuous operation on the displayed UGC;
counting time from the starting time-point of the continuous operation to obtain a timing duration in real-time;
playing a sequence of quantified feedback images that vary as the timing duration increases, until the playing of the sequence of the quantified feedback images is completed or the continuous operation ends; and
generating quantified feedback information matching the quantified feedback image displayed when the playing of the sequence of the quantified feedback images is completed or the continuous operation ends, and notifying a terminal logged in by the social-network friend.

2. The method according to claim 1, wherein the detecting a starting time-point of a continuous operation on the displayed UGC comprises:
detecting a contact point that is applied to a UGC display area displaying the UGC, or applied to a quick feedback control corresponding to the UGC, wherein the quick feedback control includes at least one of a positive quick feedback control and a negative quick feedback control;
according to a time point when the contact point is detected, determining the starting time-point of the continuous operation on the UGC; and
when the contact point disappears, determining that the continuous operation ends.

3. The method according to claim 1, wherein the playing a sequence of quantified feedback images that vary as the timing duration increases comprises one or more of:
playing a sequence of quantified feedback images whose sizes are correspondingly enlarged as the timing duration increases;
playing a sequence of quantified feedback images that shake at a correspondingly increased frequency as the timing duration increases;
playing a sequence of quantified feedback images that have a fillable area and a filled portion in the fillable area is correspondingly increased as the timing duration increases;
playing a sequence of quantified feedback images having characters that represent increased progress of the timing duration; and
playing a sequence of quantified feedback images that periodically vary every time when the timing duration reaches an integer.

4. The method according to claim 1, further comprising:
in a preset area using the played quantified feedback images as a center, playing an animation of an image element that moves as the timing duration increases, until the playing of the sequence of the quantified feedback images is completed; and
playing another animation of the image element in the preset area that diffuses outward the preset area.

5. The method according to claim 1, further comprising:
obtaining user identification information corresponding to a user identifier of the user currently logging in;
generating, according to the user identification information, a feedback record corresponding to the displayed UGC; and
displaying a quantified feedback indicator with respect to the feedback record, wherein the quantified feedback indicator matches the quantified feedback image displayed when the playing of the sequence of the quantified feedback images is completed or the continuous operation ends.

6. The method according to claim 1, wherein the UGC comprises at least one of a text, a picture, a video, and an audio.

7. A method for displaying feedback information for a user, comprising:
obtaining UGC (user generated content) and transferring the UGC to a terminal logged in by a social-network friend of the user;
obtaining quantified feedback information generated by the terminal after displaying the transferred UGC and according to a continuous operation on the displayed UGC on the terminal, where the quantified feedback information matches a timing duration of the continuous operation;
displaying the UGC and the corresponding quantified feedback information; and
playing a sequence of quantified feedback images that vary as a play time increases, until the playing of the sequence of the quantified feedback images is completed or until the play time reaches the timing duration of the continuous operation.

8. The method according to claim 7, wherein:
a contact point of the continuous operation is applied to a UGC display area of the displayed UGC on the terminal, or to a quick feedback control corresponding to the displayed UGC on the terminal; and the quick feedback control includes at least one of a positive quick feedback control and a negative quick feedback control.

9. The method according to claim 7, wherein the playing a sequence of quantified feedback images that vary as a play time increases comprises one or more of:
playing a sequence of quantified feedback images whose sizes are correspondingly enlarged as the play time increases;
playing a sequence of quantified feedback images that shake at a correspondingly increased frequency as the play time increases;
playing a sequence of quantified feedback images that have a fillable area and a filled portion in the fillable area is correspondingly increased as the play time increases;
playing a sequence of quantified feedback images having characters that represent increased progress of the play time; and
playing a sequence of quantified feedback images that periodically vary every time when the play time reaches an integer.

10. The method according to claim 7, further comprising:
in a preset area using the played quantified feedback images as a center, playing an animation of an image element that moves as the play time increases, until the playing of the sequence of the quantified feedback images is completed; and
playing another animation of the image element in the preset area that diffuses outward the preset area.

11. The method according to claim 7, further comprising:
displaying a feedback record corresponding to the UGC, wherein the feedback record is generated according to user identification information of the social-network friend; and
displaying a corresponding quantified feedback indicator with respect to the feedback record, wherein the quantified feedback indicator matches the duration of the continuous operation.

12. The method according to claim 7, wherein the UGC comprises at least one of a text, a picture, a video, and an audio.

13. A terminal for providing feedback on UGC (user generated content) by a user, comprising:
a memory storing instructions; and
a processor coupled to the memory and, when executing the instructions, configured for:
displaying UGC provided by a social-network friend of the user;
detecting a starting time-point of a continuous operation on the displayed UGC;
counting time from the starting time-point of the continuous operation to obtain a timing duration in real-time;
playing a sequence of quantified feedback images that vary as the timing duration increases, until the playing of the sequence of the quantified feedback images is completed or the continuous operation ends; and
generating quantified feedback information matching the quantified feedback image displayed when the playing of the sequence of the quantified feedback images is completed or the continuous operation ends, and notifying a terminal logged in by the social-network friend.

14. The terminal according to claim 13, wherein the detecting a starting time-point of a continuous operation on the displayed UGC comprises:
detecting a contact point that is applied to a UGC display area displaying the UGC, or applied to a quick feedback control corresponding to the UGC, wherein the quick feedback control includes at least one of a positive quick feedback control and a negative quick feedback control;
according to a time point when the contact point is detected, determining the starting time-point of the continuous operation on the UGC; and
when the contact point disappears, determining that the continuous operation ends.

15. The terminal according to claim 13, wherein the playing a sequence of quantified feedback images that vary as the timing duration increases comprises one or more of:
playing a sequence of quantified feedback images whose sizes are correspondingly enlarged as the timing duration increases;
playing a sequence of quantified feedback images that shake at a correspondingly increased frequency as the timing duration increases;
playing a sequence of quantified feedback images that have a fillable area and a filled portion in the fillable area is correspondingly increased as the timing duration increases;
playing a sequence of quantified feedback images having characters that represent increased progress of the timing duration; and
playing a sequence of quantified feedback images that periodically vary every time when the timing duration reaches an integer.

16. The terminal according to claim 13, the processor further configured for:
in a preset area using the played quantified feedback images as a center, playing an animation of an image element that moves as the timing duration increases, until the playing of the sequence of the quantified feedback images is completed; and
playing another animation of the image element in the preset area that diffuses outward the preset area.

17. The terminal according to claim 13, the processor further configured for:
obtaining user identification information corresponding to a user identifier of the user currently logging in;
generating, according to the user identification information, a feedback record corresponding to the displayed UGC; and
displaying a quantified feedback indicator with respect to the feedback record, wherein the quantified feedback indicator matches the quantified feedback image displayed when the playing of the sequence of the quantified feedback images is completed or the continuous operation ends.

18. The terminal according to claim 13, wherein the UGC comprises at least one of a text, a picture, a video, and an audio.
